(19) United States
(12) Patent Application Publication
(10) Pub. No.: US 2017/0341094 A1
(43) Pub. Date: Nov. 30, 2017

(54) TUNNEL FAN AND METHOD

(71) Applicant: Twin City Fan Companies, Ltd., Plymouth, MN (US)

(72) Inventors: Daniel Khalitov, St. Louis Park, MN (US); Radha Krishna Ganesh, Rogers, MN (US); Daniel Hartlein, Saint Michael, MN (US); Trinity Persful, Maple Grove, MN (US)

(21) Appl. No.: 15/606,268

(22) Filed: May 26, 2017

Related U.S. Application Data
(60) Provisional application No. 62/342,244, filed on May 27, 2016.

(51) Int. Cl. B05B 3/10; F24F 11/00; E21F 1/00; E21F 5/06; E21F 3/00

(52) U.S. Cl. CPC B05B 3/105; F24F 11/0001; E21F 1/00; E21F 3/00; E21F 5/06

(57) ABSTRACT

A fan assembly, and associated methods are shown. Fan assemblies and methods shown include nozzles within a housing of the fan. Fan assemblies and methods shown may provide water and/or fire suppression chemicals within a fan housing that provide characteristics such as increased thrust and motor cooling effects.

### PRIORITY

This patent application claims the benefit of U.S. Provisional Patent Application No. 62/342,244, filed May 27, 2016, which is incorporated by reference herein in its entirety.

### TECHNICAL FIELD

Embodiments described herein generally relate to fan assemblies and devices that utilize fan assemblies. Specific embodiments may include fans and fan systems adapted for use in tunnel applications.

### BACKGROUND

Fans are used in a number of ways that may aid in controlling a fire. Improved fan assemblies are desired for fire related applications. In one example, fans may be used to remove smoke from a vicinity of a fire. Tunnel fires present special problems due to the consumption of oxygen by the fire disrupting normal air flow.

### BRIEF DESCRIPTION OF THE DRAWINGS

FIG. 1 shows a fan assembly according to an example of the invention.

FIG. 2 shows the fan assembly from FIG. 1 in one state of operation according to an example of the invention.

FIG. 3 shows the fan assembly from FIG. 1 in another state of operation according to an example of the invention.

FIG. 4 shows the fan assembly from FIG. 1 in another state of operation according to an example of the invention.

FIG. 5 shows another fan assembly according to an example of the invention.

FIG. 6 shows a number of fan assemblies in a tunnel in one state of operation according to an example of the invention.

FIG. 7 shows a method of operating a fan assembly according to an example of the invention.

### DESCRIPTION OF EMBODIMENTS

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

FIG. 1 shows a fan assembly 100 according to one example. In FIG. 1, the fan assembly 100 includes a housing 110 that defines an air flow channel between a first end 112 and a second end 114 of the housing 110. In one example, the housing 110 is cylindrical. Other examples of housing configurations include square or rectangular cross sectional housings.

An impeller 122 is shown located within a middle portion of the housing 110. In the example shown, the impeller 122 is attached to an axle of a motor 124 that is also located within the middle portion of the housing 110. In other examples, a motor, or other driving mechanism, may be located external to the housing, and a transmission may be coupled to the impeller 122. In the example of FIG. 1, controlling circuitry 126 is shown coupled to the motor 124. In operation, the controlling circuitry 126 may select a direction of air flow through the housing 110, as created by the impeller 122.

A first nozzle 130 is located within the air flow channel between the impeller 122 and the first end 112 of the housing 110. A second nozzle 132 is located within the air flow channel between the impeller 122 and the second end 114 of the housing. In the example of FIG. 1, an additional third nozzle 134 is shown located on the same side of the impeller 122 as the first nozzle 130. An additional fourth nozzle 136 is also shown located on the same side of the impeller 122 as the second nozzle 132. Although multiple nozzles are shown on each side of the impeller in the example of FIG. 1, the invention is not so limited. In other examples, a single nozzle may be located on either side of the impeller 122, or more than two nozzles may be located on either side of the impeller 122.

In the example of FIG. 1, the nozzles are shown located between a wall of the housing 110 and a center axis 108 of the housing 110. In other examples, the nozzles are located on a wall of the housing 110. In other examples, the nozzles are located at any location or a mix of locations where a spray discharge is directed within the housing 110. In one example, the nozzles are configured to provide an atomized mist, although the invention is not so limited. Other nozzle configurations may provide different gradations of spray or degree of aeration apart from atomization. In one example, a water mist system such as atomized water, may disturb smoke layers more than sprinkler and more effectively control or suppress a fire.

A water supply 140 is shown in block diagram format. The water supply 140 is coupled to one or more of the nozzles as described above. A fire suppression chemical supply 142 is also shown in block diagram format in FIG. 1, and may optionally be used, in addition to the water supply 140 in fire suppression operations described in more detail below. No specific plumbing configuration is shown, however, one of ordinary skill in the art, having the benefit of the present disclosure, will recognize how to couple the water supply 140 and/or the fire suppression chemical supply 142 to one or more of the nozzles.

In one example, the fan assembly 100 may be operated only as a fan. The circuitry 126 may select a direction of air flow toward either the first end 112 or the second end 114 of the housing 110, and the nozzles remain unused.

In one example, the fan assembly 100 may be operated to provide air flow while concurrently, the nozzles provide an amount of water within the housing 110. The addition of water within the housing 110 provides a number of advantages. In one example, water added to the air flow within the housing 110 helps the fan assembly develop up to 25% higher thrust when compared to air alone, which can provide better circulation in the event of a fire. In one example, the motor 124 size is chosen to account for the increased density of mater added to the airflow, and the resulting increase in thrust. In one example, an AC motor is sized at 75% of full load, where the full load accounts for the optional additional density of water added within the housing 110.

The addition of water within the housing 110 also provides a cooling effect to the fan motor 124 as shown in FIG. 1, located within the housing 110. Cooling of the motor 124 during operation provides the ability for the fan assembly 100 to operate for prolonged periods of time at higher airstream temperatures. This can be advantageous during a fire. In some scenarios, a fan motor that is not cooled may fail prematurely due to the elevated temperatures of the airstream within a fire situation.

In one example, the fan assembly 100 may be operated only as water dispersal device. For example, if the fan motor 124 were to fail, the water supply 140 will continue to function and provide a level of fire suppression. It is beneficial to continue to have water being supplied to a fire zone, even after the fan motor 124 has failed.

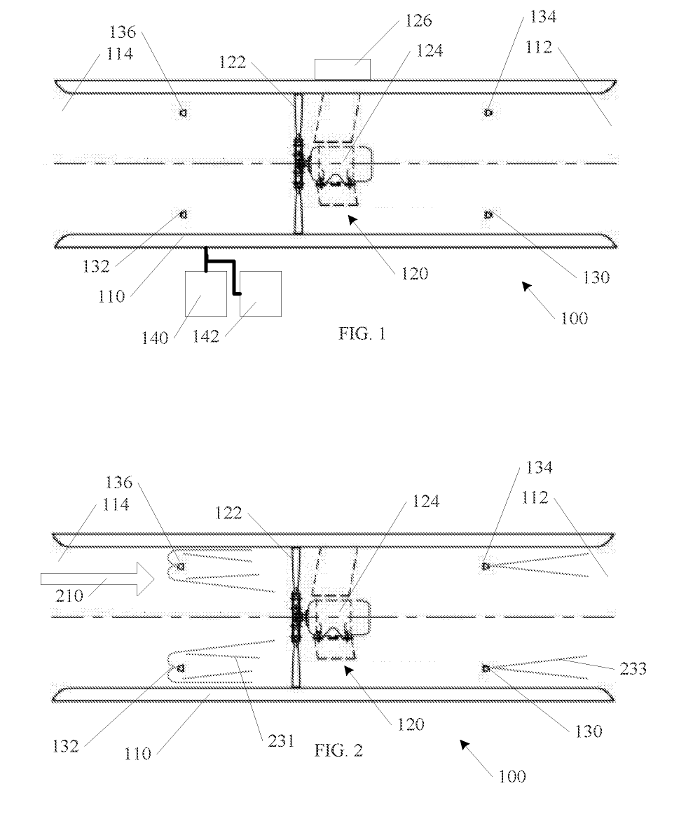

FIG. 2 shows the fan assembly 100 operating with an air flow direction 210. In this configuration, the second nozzle 132 and the fourth nozzle 136 are upstream nozzles. As shown in the Figure, water 231 from the second nozzle 132 and the fourth nozzle 136 is directed over the fan motor 124. In this configuration, the first nozzle 130 and the third nozzle 134 are downstream nozzles. Water 233 from the first nozzle 130 and the third nozzle 134 is directed out of the first end 112 of the housing 110.

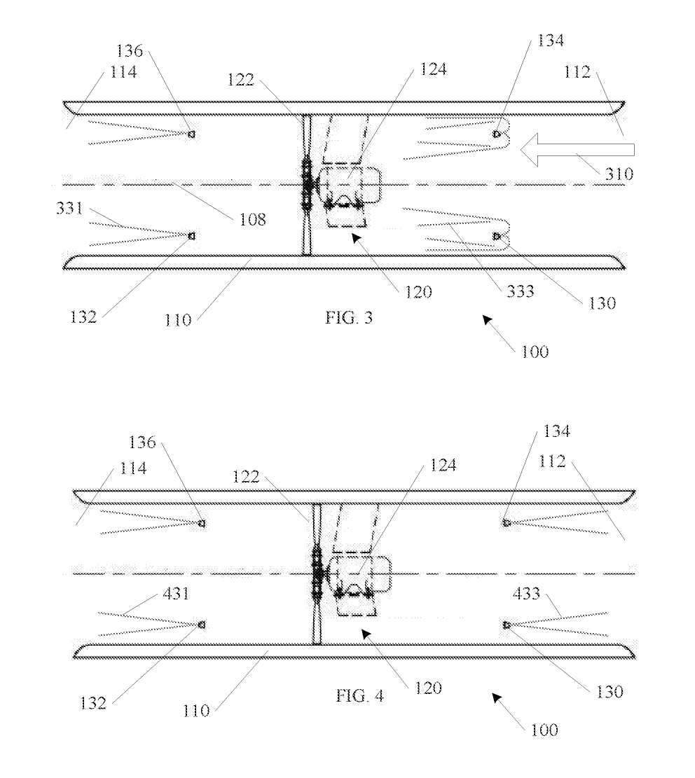

In one example, the fan assembly 100 is reversible in air flow direction. FIG. 3 shows the fan assembly 100 operating with an air flow direction 310, opposite to direction 210 shown in FIG. 2. In this configuration, the first nozzle 130 and the third nozzle 134 are upstream nozzles. As shown in the Figure, water 333 from the first nozzle 130 and the third nozzle 134 is directed over the fan motor 124. In this configuration, the second nozzle 132 and the fourth nozzle 136 are downstream nozzles. Water 331 from the second nozzle 132 and the fourth nozzle 136 is directed out of the second end 114 of the housing 110. As can be seen from FIGS. 2 and 3, using nozzle configurations as shown, in either operating direction, the motor 124 is cooled by water passing over it.

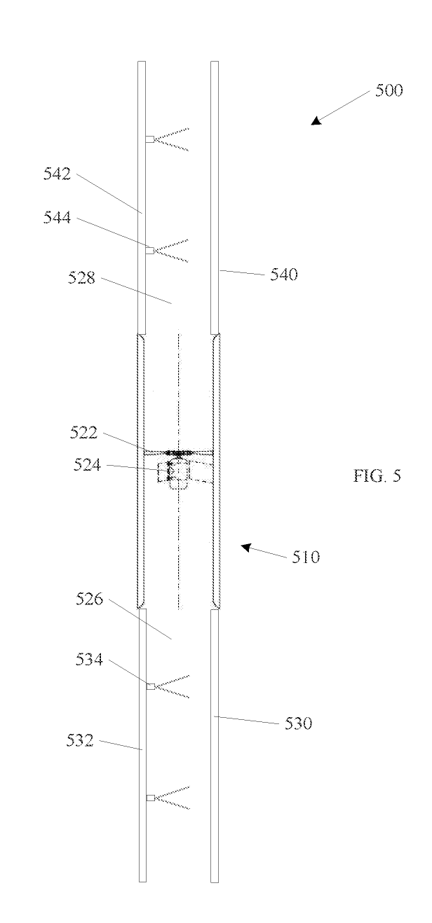

FIG. 4 illustrates operation of the fan assembly 100 after motor failure, or otherwise with the motor 124 not in operation. All nozzles 130, 132, 134, and 136 are still providing water flow, but the water may not be drawn over the motor 124 when it is not in operation. However the introduction of water to the fire zone is still being accomplished.

FIG. 5 illustrates another example of a fan assembly 500. The fan assembly 500 includes a housing 510 similar to examples described above. An impeller 522 is shown coupled to a motor 524 and located within the housing 510. FIG. 5 illustrates the addition of one or more silencers to the fan assembly 500.

A first silencer 530 is shown coupled to an end of the housing 510. A second silencer 540 is shown coupled to an opposite end of the housing 510 to the first silencer 530. A first nozzle 534 is located on a first axial side 526 of the impeller 522. A second nozzle 544 is located on a second axial side 528 of the impeller 522 opposite the first axial side 526.

In the example shown, there are multiple nozzles on both the first axial side 526 and the second axial side 528, although the invention is not so limited. In the example shown, the nozzles are located on respective walls 532 and 542 of the first silencer 530 and second silencer 540. As with examples above, other locations within the silencers 530, 540 are also within the scope of the invention. Although two silencers are shown in FIG. 5, other examples may include only a single silencer, with one set of either upstream or downstream nozzles being located within the housing 510 instead of within a silencer.

In one example one or more of the silencers 530, 540 includes a sound suppression material located on or within walls 532, 542 of the silencers 530, 540. In one example, a metal wool material may be included between hollow walls of one or more of the silencers 530, 540. Perforations within the hollow walls in combination with the metal wool material provides a level of noise suppression that is desirable in many fan assemblies. In particular, in a tunnel ventilation setting, it is desirable to include noise suppression configurations such as silencers 530, 540 because of the inherent echo within a tunnel.

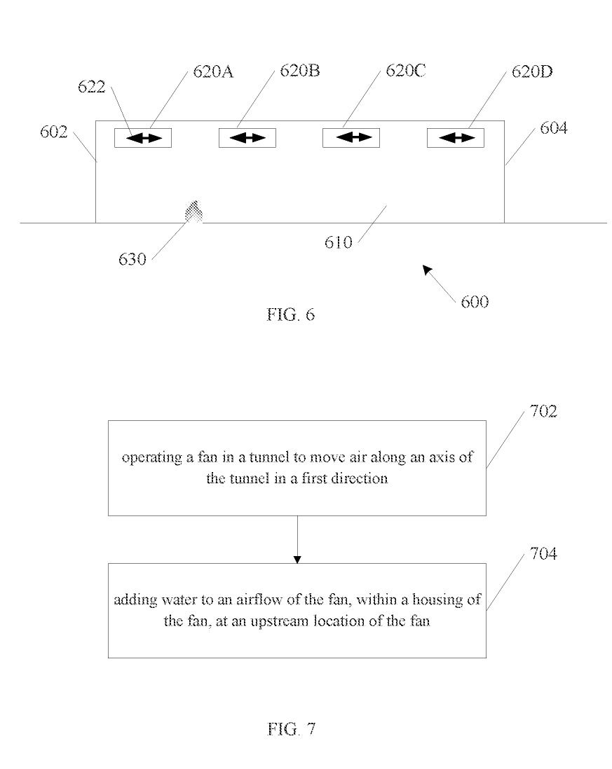

FIG. 6 shows a tunnel system 600 that includes multiple fan assemblies as described in embodiments above. A tunnel 610 is illustrated with a plurality of fan assemblies 620A, 620B, 620C, and 620D. The tunnel 600 is shown with a first end 602 and a second end 604. In the event of a fire 630, each individual fan assembly 620A, 620B, 620C, and 620D may be selected to operate in an optimal direction to control or suppress the fire 630.

In the example shown, fan assembly 620A may operate in either direction 622, to draw smoke away from the fire 630. The remaining fan assemblies 620B, 620C, and 620D may operate in coordination with fan 620A, to also draw smoke away from the fire 630. In one example, the fan assemblies 620A, 620B, 620C, and 620D may be operated in either direction as indicated in the Figure, with a selected direction that best removes smoke.

In addition to drawing away smoke, as described above, one or more of the fan assemblies 620A, 620B, 620C, and 620D may be equipped with nozzles that introduce water and/or fire suppression chemicals to the system 600. This configuration provides the additional benefits as described above. For example, increasing thrust of the fan assemblies 620A, 620B, 620C, and 620D, and cooling respective fan motors in the fan assemblies 620A, 620B, 620C, and 620D.

FIG. 7 shows a flow diagram of selected methods of operation. In operation 702, a fan is operated in a tunnel to move air along an axis of the tunnel in a first direction. In operation 704, water is added to an airflow of the fan, within a housing of the fan, at an upstream location of the fan. As discussed above, this provides a number of advantages such as increasing thrust of the fan assembly and providing cooling to fan motors.

To better illustrate the method and apparatuses disclosed herein, a non-limiting list of embodiments is provided here:

Example 1 includes a fan assembly. The fan assembly includes a housing open on two ends, the housing defining an air flow channel between a first end of the housing, and a second end of the housing, an impeller located within a middle portion of the housing, a first nozzle located within the air flow channel between the impeller and the first end of the housing, and a second nozzle located within the air flow channel between the impeller and the second end of the housing.

Example 2 includes the fan assembly of example 1 wherein the housing includes a cylindrical housing.

Example 3 includes the fan assembly of any one of examples 1-2, wherein there are multiple nozzles on each side of the impeller.

Example 4 includes the fan assembly of any one of examples 1-3, further including a switch coupled to the impeller, wherein the switch is configured to optionally blow air toward either the first end of the housing or the second end of the housing.

Example 5 includes the fan assembly of any one of examples 1-4, wherein the first nozzle and the second nozzle are located on a wall of the housing.

Example 6 includes the fan assembly of any one of examples 1-5, wherein the first nozzle and the second nozzle are located between a wall of the housing and a center axis of the housing.

Example 7 includes the fan assembly of any one of examples 1-6, wherein first nozzle and the second nozzle are connected to a water supply.

Example 8 includes the fan assembly of any one of examples 1-7, wherein the first nozzle and the second nozzle are further connected to a fire suppression chemical supply.

Example 9 includes the fan assembly of any one of examples 1-8, wherein the first nozzle and the second nozzle are configured to provide an atomized mist.

Example 10 includes a fan assembly, including a housing open on two ends, the housing defining an air flow channel between a first end of the housing, and a second end of the housing, an impeller located within a middle portion of the housing, a first silencer coupled to at least one of the first and second ends of the housing, a first nozzle located on a first axial side of the impeller, and a second nozzle located on a second axial side of the impeller opposite the first axial side.

Example 11 includes the fan assembly of example 10, further including a second silencer coupled to an end of the housing opposite the first silencer.

Example 12 includes the fan assembly of any one of examples 10-11, wherein at least one of the first nozzle and second nozzle is located within the first silencer.

Example 13 includes the fan assembly of any one of examples 10-12, wherein the first nozzle is located within the first silencer and the second nozzle located within the second silencer.

Example 14 includes the fan assembly of any one of examples 10-13, wherein the first nozzle and the second nozzle are connected to a water supply.

Example 15 includes the fan assembly of any one of examples 10-14, wherein the first nozzle and the second nozzle are further connected to a fire suppression chemical supply.

Example 16 includes the fan assembly of any one of examples 10-15, wherein the first nozzle and the second nozzle are configured to provide an atomized mist.

Example 17 includes a method, including operating a fan in a tunnel to move air along an axis of the tunnel in a first direction, and adding water to an airflow of the fan, within a housing of the fan, at an upstream location of the fan.

Example 18 includes the method of example 17, wherein adding water to an airflow of the fan includes adding water concurrently at both an upstream and a downstream location of the fan.

Example 19 includes the method of any one of examples 17-18, further including detecting a fire location within the tunnel, and selecting a fan direction away from the fire.

Example 20 includes the method of any one of examples 17-19, wherein multiple fans are included within the tunnel, and wherein selecting a fan direction away from the fire includes selecting multiple different fan directions away from the fire.

Example 21 includes the method of any one of examples 17-20, further including operating only a water supply in the event of a power failure where the fan is disabled.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A fan assembly, comprising:
a housing open on two ends, the housing defining an air flow channel between a first end of the housing, and a second end of the housing;
an impeller located within a middle portion of the housing;
a first nozzle located within the air flow channel between the impeller and the first end of the housing; and
a second nozzle located within the air flow channel between the impeller and the second end of the housing.

2. The fan assembly of claim 1, wherein the housing includes a cylindrical housing.

3. The fan assembly of claim 1, wherein there are multiple nozzles on each side of the impeller.

4. The fan assembly of claim 1, further including a switch coupled to the impeller, wherein the switch is configured to optionally blow air toward either the first end of the housing or the second end of the housing.

5. The fan assembly of claim 1, wherein the first nozzle and the second nozzle are located on a wall of the housing.

6. The fan assembly of claim 1, wherein the first nozzle and the second nozzle are located between a wall of the housing and a center axis of the housing.

7. The fan assembly of claim 1, wherein the first nozzle and the second nozzle are connected to a water supply.

8. The fan assembly of claim 7, wherein the first nozzle and the second nozzle are further connected to a fire suppression chemical supply.

9. The fan assembly of claim 1, wherein the first nozzle and the second nozzle are configured to provide an atomized mist.

10. A fan assembly, comprising:
a housing open on two ends, the housing defining an air flow channel between a first end of the housing, and a second end of the housing;
an impeller located within a middle portion of the housing;
a first silencer coupled to at least one of the first and second ends of the housing;
a first nozzle located on a first axial side of the impeller; and
a second nozzle located on a second axial side of the impeller opposite the first axial side.

11. The fan assembly of claim 10, further including a second silencer coupled to an end of the housing opposite the first silencer.

12. The fan assembly of claim 10, wherein at least one of the first nozzle and second nozzle is located within the first silencer.

13. The fan assembly of claim 11, wherein the first nozzle is located within the first silencer and the second nozzle located within the second silencer.

14. The fan assembly of claim 10, wherein the first nozzle and the second nozzle are connected to a water supply.

15. The fan assembly of claim 14, wherein the first nozzle and the second nozzle are further connected to a fire suppression chemical supply.

16. The fan assembly of claim 10, wherein the first nozzle and the second nozzle are configured to provide an atomized mist.

17. A method, comprising:
operating a fan in a tunnel to move air along an axis of the tunnel in a first direction; and
adding water to an airflow of the fan, within a housing of the fan, at an upstream location of the fan.

18. The method of claim 17, wherein adding water to an airflow of the fan includes adding water concurrently at both an upstream and a downstream location of the fan.

19. The method of claim 17, further including detecting a fire location within the tunnel, and selecting a fan direction away from the fire.

20. The method of claim 19, wherein multiple fans are included within the tunnel, and wherein selecting a fan direction away from the fire includes selecting multiple different fan directions away from the fire.

21. The method of claim 17, further including operating only a water supply in the event of a power failure where the fan is disabled.
